(19) United States
(12) Patent Application Publication
(10) Pub. No.: US 2024/0119189 A1
(43) Pub. Date: Apr. 11, 2024

(54) METHODS AND SYSTEMS OF PROGRAMATICALLY GENERATING PLOT PLANS

(71) Applicant: Production Builder Services, LLC, Duluth, GA (US)

(72) Inventors: Gavin P. Bacchus, Sugar Hill, GA (US); Stacy L. Carter, Atlanta, GA (US)

(21) Appl. No.: 17/963,861

(22) Filed: Oct. 11, 2022

(51) Int. Cl. G06F 30/13; G06F 30/20; G06K 9/62; G06Q 50/16

(52) U.S. Cl. CPC G06F 30/13; G06F 30/20; G06K 9/6272; G06Q 50/165; G06F 2111/20

(57) ABSTRACT

Disclosed are various embodiments for methods and systems of programmatically generating plot plans. Plot plans, also called lot plans, are documents that describe and demonstrate various elements of a lot in a subdivision, block or neighborhood. Various embodiments can generate these plot plans programmatically based on certain rules. Various embodiments require the use of imaging software, such as computer aided design software or command line image manipulation software. Various embodiments also require connecting the imaging software with a data store to perform these actions for a plurality of different lots for subdivisions.

### BACKGROUND

To build a home, certain documents must be prepared for various uses. For instance, architects, surveyors, and contractors may prepare documents used to build a new home, building, or structure. These documents may also be used for obtaining permits and/or licenses to start building. These documents are often quite tedious and require the utmost precision to make, which means the architects, surveyors, and contractors often spend a considerable amount of time preparing these documents by hand. Additionally, to make these drawings, architects, surveyors, and contractors often must be skilled in Computer-Aided Design (CAD) technologies, which can further limit the number of people capable of generating these documents.

### BRIEF SUMMARY OF THE INVENTION

Disclosed are various systems and methods for programmatically generating plot plans and lot documents used in construction. Said systems and methods can be executed to send instructions to, control, or otherwise direct imaging software to generate output lot documents from subdivision plats, house plans, templates, and orders. To briefly describe the functionality of the systems and methods, said systems and methods can begin by obtaining orders that direct the plat application to generate output lot documents. Said systems and methods can obtain templates and a specified subdivision plat, as specified in the order. Said systems and methods can check to see whether a specified lot plan exists in a subdivision plat. If a lot plan does not exist in a subdivision plat, embodiments can find a specified lot by a lot number in the subdivision plat and create a lot plan from the subdivision plat. If the lot plan exists in the subdivision plat, then embodiments can obtain the lot plan from the subdivision plat. Systems and methods can then generate a lot document from a template and replace the placeholder templating fields with data from the order, the subdivision plat, or the lot plan.

Next, embodiments of this application can direct the imaging software to combine the drawing in the lot plan and the lot document that was generated from the template as a single document. The embodiments of this application can direct the imaging software to rotate the lot document independently of the lot plan to ensure the cardinality of the lot is correct for the template. The embodiments of this application can direct the imaging software to position the lot plan in a specified manner. The embodiments of this application can then check if the lot plan fits on the lot document without intersecting with the contents of the lot document. In the situation where the lot plan intersects with the contents of the lot document, the embodiments of this application can determine whether the lot document can be resized to fit the lot plan. If the lot plan can be resized, the embodiments of this application can direct the imaging software to resize the lot document and try to re-position the lot plan on the lot document. If the lot document cannot be resized or if the lot plan fits on the lot document without intersecting its contents, then the embodiments of this application can generate curve/line charts and data. The embodiments of this application can then format the lot document and lot plan according to the final scale used.

Next, the embodiments of this application can check if a house plan is specified in the order. If a house plan is not specified in the order, the embodiments of this application can store the lot document as an output lot document in the data store. If a house plan is specified in the order, then the embodiments of this application can obtain the house plan from the data store. The embodiments of this application can then combine the drawing of the house plan onto the lot document. The embodiments of this application can then direct the imaging software to rotate and resize the house plan to fit in the lot. The embodiments of this application can direct the imaging software to draw the additional structures on the lot document. The embodiments of this application can then calculate additional information about the house plan as it relates to the lot plan on the lot document. Finally, the embodiments of this application can store the lot document as an output lot document in the data store.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2A-C are pictorial diagrams of example document views rendered by an application in the network environment of FIG. 1 according to various embodiments of the present disclosure.

FIGS. 3A-D are flowcharts illustrating one example of functionality implemented as portions of an application executed in a computing environment in the network environment of FIG. 1 according to various embodiments of the present disclosure.

### DETAILED DESCRIPTION

Disclosed are various approaches for programmatically generating plot plans and lot documents. Various embodiments can programmatically extract important information from pre-existing documents, prepare the presentation of lot documents, and calculate important information to be compliant with government permitting and licensing schemes. To build a home, certain documents must be prepared for various uses. For instance, architects, surveyors, and contractors may prepare documents used to build a new home, building, or structure. These documents may also be used for obtaining permits and/or licenses to start building. These documents are often quite tedious and require the utmost precision to make, which means the architects, surveyors, and contractors often spend a considerable amount of time preparing these documents by hand. These documents often take architects, surveyors, and contractors hours to generate due to their complexity. Various embodiments can generate these documents quickly, without the intervention of an architect, surveyor, or contractor.

Additionally, architects, surveyors, and contractors often must be skilled in Computer-Aided Design (CAD) technologies, such as AutoCAD, Fusion 360, and/or other similar software, to make these documents. These CAD technologies are often difficult to use, requiring a great amount of training. As such, there are few skilled workers who can generate these documents. Various embodiments disclose the creation of these documents programmatically with little to no human intervention.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

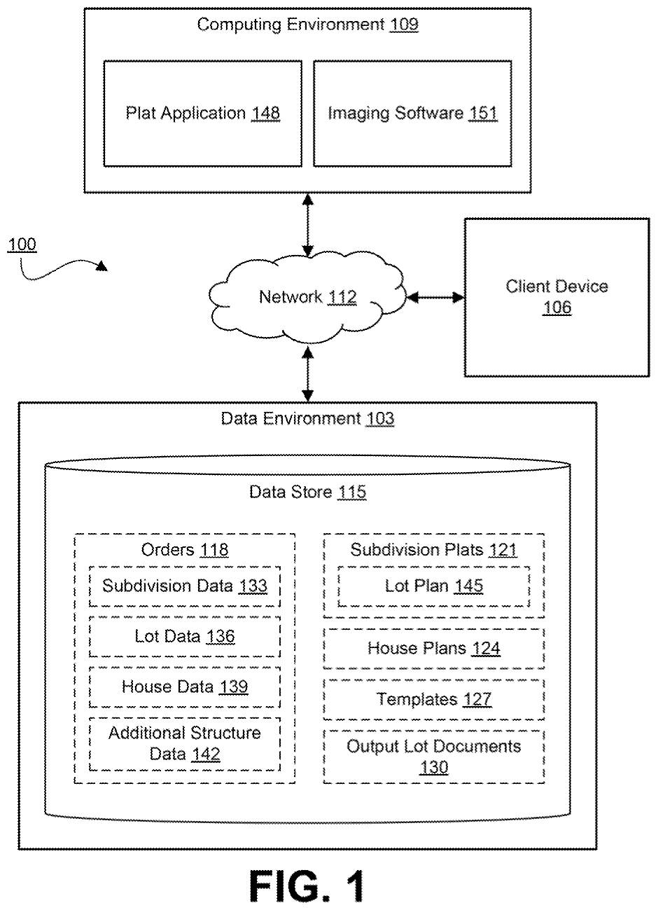

With reference to FIG. 1, shown is a network environment 100 according to various embodiments. The network environment 100 can include a data environment 103, a client device 106, and a computing environment 109, which can be in data communication with each other via a network 112.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-Fi®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The data environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the data environment 103 can employ a plurality of computing devices that can be arranged in one or more server banks or computer banks or other arrangements. Such computing devices can be located in a single installation or can be distributed among many different geographical locations. For example, the data environment 103 can include a plurality of computing devices that together can include a hosted computing resource, a grid computing resource, or any other distributed computing arrangement. In some cases, the data environment 103 can correspond to an elastic computing resource where the allotted capacity of processing, network, storage, or other computing-related resources can vary over time.

Various applications or other functionality can be executed in the data environment 103. The components executed on the data environment 103 include data store applications, and other applications, services, processes, systems, engines, or functionality not discussed in detail herein.

Also, various data is stored in a data store 115 that is accessible to the data environment 103. The data store 115 can be representative of a plurality of data stores 115, which can include relational databases or non-relational databases, such as object-oriented databases, hierarchical databases, hash tables or similar key-value data stores, as well as other data storage applications or data structures. Moreover, combinations of these databases, data storage applications, and/or data structures may be used together to provide a single, logical, data store 115. The data stored in the data store 115 is associated with the operation of the various applications or functional entities described below. This data can include orders 118, subdivision plats 121, house plans 124, templates 127, and output lot documents 130, and potentially other data.

The orders 118 can represent a directive to an application, such as the plat application 148, to generate documents according to various specifications. The order 118 may include a status to indicate whether a document should be generated. The order 118 may also include order tracking information, such as an order identifier, the date/time the order was placed, the date/time a permit is due to a governing body, or other such information. The orders 118 can further include subdivision data 133, lot data 136, house data 139, and additional structure data 142, which will be further explained below, as well as various other data. The order 118 can also include information to identify a specific template 127 to use to generate an output lot document 130. The order 118 can include a template identification and various other information that may be required to populate the placeholders of the template 127.

The subdivision data 133 can represent any specific subdivision information necessary to generate the output lot documents 130. The subdivision data 133 can dictate which subdivision plat 121 the lot will be generated from. For instance, the subdivision data 133 can include a subdivision identifier that corresponds to a specified subdivision plat 121. The subdivision data 133 can also include information that may need to be displayed in the output lot documents 130 that may not otherwise be stored in relation to the subdivision plats 121. For instance, certain jurisdictions can require an output lot document 130 to include the current progress of the neighborhood (percentage builds completed in the neighborhood, total amount in progress in the neighborhood, etc.). As such, the subdivision data 133 of an order 118 can include information related to the current progress of the neighborhood.

The lot data 136 can represent order 118 specific information related to a lot depicted on a subdivision plat 121. For example, the lot data 136 can include a lot identifier or a lot number which identifies the lot depicted in a subdivision plat 121. In at least another embodiment where the subdivision plat 121 includes individual lot plans 145, the lot data 136 can include an identifier that specifies such a lot plan 145. Additionally, the lot data 136 can include information that may need to be displayed in the output lot documents 130 that may not otherwise be stored in the subdivision plats 121 or lot plans 145. For instance, a specific address (street name, number, city, state, zip/postal code, etc.) for the lot can be included in the lot data 136. In at least another example, the lot data 136 can include a cardinality or direction the lot should be placed in the output lot documents 130. Although many jurisdictions require the lot to be arranged with respect to due north cardinality, other jurisdictions can require that the front of the lot, adjacent to a Right of Way (“ROW”), be aligned parallel to the bottom of the output lot document 130. The direction or cardinality can be configured on a house-by-house basis due to the specific requirements needed in the jurisdiction. Additionally, other information can be included in the lot data 136. Examples of other information that can be included in the lot data 136 include a minimum and/or maximum distance from the ROW that the house must be built, flood plain information, ways to identify the starting point of a lot's boundary, general notes, and/or other various types of information.

The house data 139 can represent order 118 specific information related to a house to be placed on a lot from a subdivision plat 121. For example, the house data 139 can include a house identifier or a house style that represents a specified style of house plan 124 to be placed on the lot. In some embodiments, house plans 124 can include a base model and various options that allow a homebuyer to customize their home to their liking. The options can often influence the underlying dimensions of a house plan 124, so tracking the specific options can be critical to building a house correctly. As such, the house data 139 can be configured to track the specific options related to the house plans 124. In at least one embodiment, the house data 139 can include dimensions of the foundation of a house if it is not already specified in a house plan 124. The house data 139 can also include various information that can affect the placement of the house plan 124 onto the lot or the lot plan 145. For instance, the house data 139 may indicate that the house needs to be placed in a certain distance from the ROW. In at least another embodiment, the house data 139 can include a cardinality or a direction in which the house faces. Additionally, the house data 139 can include other information such as builder and contractor contact information, dates related to the scheduled build, or other information that jurisdictions may include to obtain a permit or building license.

The additional structure data 142 can represent specific information related to additional structures (fences, detached garages, pools, gazebos, sheds, driveways, etc.) to be placed on a lot from a subdivision plat 121. For example, the additional structure data 142 can include whether any additional structure (fences, detached garages, pools, gazebos, sheds, etc.) should be included on the lot, any distances from lot boundaries, any distances from the house, dimensions of the additional structure, direction of the additional structure, and/or other types of information. Additionally, the additional structure data 142 can include other information specific to the type of structure, such a pool depth, fence height, landscaping information, and various other types of information.

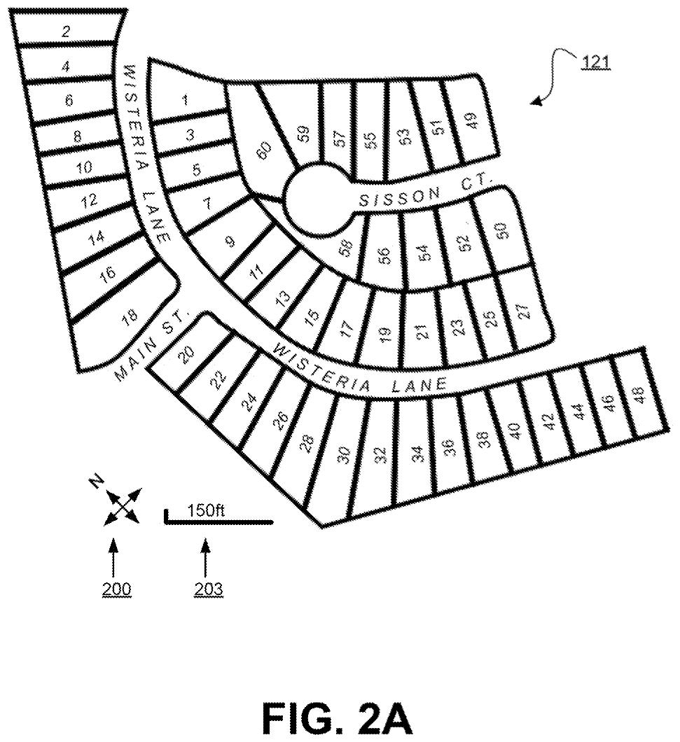

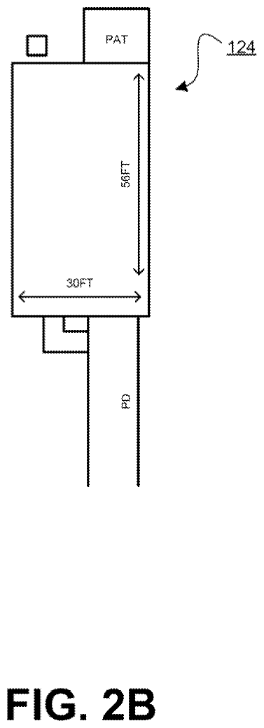

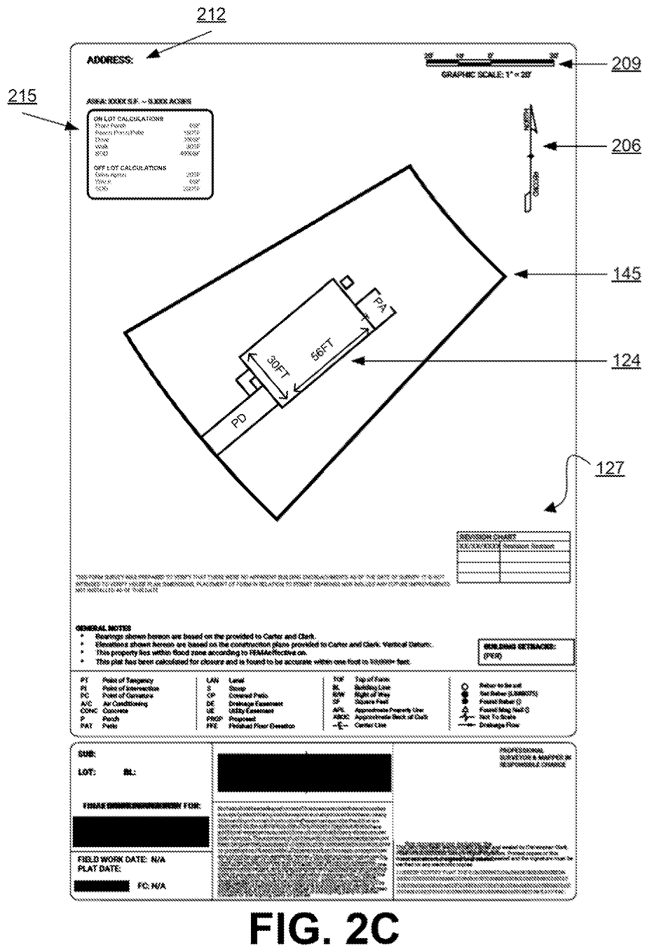

The subdivision plats 121 can represent a two-dimensional drawing of a subdivision, neighborhood, or block that contains a plurality of lines that represent the borders of lots as well as corresponding information to identify the meaning of such lines. In many embodiments, the subdivision plats 121 can be formatted as a CAD file, such as an AutoCAD file, a Fusion 360 file, or other various file types used in CAD software. An example of a subdivision plat 121 can be seen in FIG. 2A. A subdivision plat 121 can depict the boundaries or borders of a plurality of lots in the subdivision, neighborhood, or block depicted. The boundaries or borders can enclose a space which is often referred to as a lot. In some embodiments, some or all of the lots can be extracted from a subdivision plat 121 and saved individually as a lot plan 145. In other embodiments, each lot can be stored on its own layer of a CAD file, which allows for the easy access and identification of such lot.

In many embodiments, a subdivision plat 121 will include one or more lot numbers, where each lot number is unique to a specific lot. In at least some embodiments, a subdivision plat 121 can include street names or other location identifiers. In at least some embodiments, a subdivision plat 121 can include a topographical map or a topographical map layer that depicts the three-dimensional depth of the lot in two dimensions. The subdivision plat 121 can also include other topographical information such as identification of ponds, rivers, creeks, boulders, cliffs, or other topography.

In many embodiments, the subdivision plat 121 can also include a scale to correlate the size of the depicted drawings to the size of the subdivision as it exists in the real world. The scale is often displayed as ratio, but can be depicted in various ways in certain subdivision plats 121. The subdivision plat 121 can also include a cardinal direction or compass to identify how the neighborhood is rotationally situated. In at least one example, the subdivision plat 121 can include an arrow with the letter “N” next to it to indicate that north is in the pointed direction. Similar embodiments could be used for letters “E,” “S”, “W,” “NE,” “NW”, “SE,” “SW,” “NNE”, etc., to correlate to the cardinal directions of east, south, west, northeast, northwest, southeast, southwest, north-northeast, and other similar styles of directions. Various other ways can also be used to identify the direction of the subdivision plat 121.

The subdivision plat 121 can also include additional information or metadata corresponding to the subdivision, such as subdivision name, state, city, zip code, utilities connected, adjacent street names, or other various information. A subdivision plat 121 can also include certain building code rules, such as requirements to build houses a specified distance from a street and/or other types of building code rules.

The lot plan 145 can represent a two-dimensional drawing of a specific lot from a subdivision plat 121. The lot plan 145 can include two-dimensional drawn lines that represent a lot border or lot boundary. A lot plan 145 can be formatted as a CAD file, such as an AutoCAD file, a Fusion 360 file, or other various file types used in CAD software. Alternatively, a lot plan 145 can be formatted as a layer in a CAD file for a subdivision Plat 121, which allows you to individually identify each lot and isolate it from the other lots in a subdivision plat 121. A lot plan 145 can also include additional information or metadata corresponding to the specified lot, such as a lot number, state, city, zip code, utilities connected to the lot, adjacent street names, or other various information. Additionally, a lot plan 145 can also include certain building code rules, such as rules that indicate to build only in certain areas of a lot due to flood plain or other topographical concerns, such as rivers, creeks, lakes, boulders, cliffs, etc.

The house plans 124 can represent a two-dimensional drawing of a specific house that could be placed on a lot in a subdivision plat 121. A house plan 124 can be formatted as a CAD file, such as an AutoCAD file, a Fusion 360 file, or other various file types used in CAD software. In some embodiments, a house plan 124 represents a finalized drawing of a house. However, in some embodiments, a house plan 124 can include a base model of a house and various options that allow a homebuyer to customize their home to their liking. The options can often influence the underlying dimensions of a house plan 124, which also affect the drawing. Each option and the base model could be placed on a different layer of a CAD file. The house plan can include additional information related to the house, such as dimensions, scale, or other information.

The templates 127 can represent a two-dimensional document having placeholders or templating fields that can be replaced with data relevant to the output of a lot document. FIGS. 2B and 2C depict templates 127. A template 127 can be a mixture of shape information and text information as depicted in a drawing. The templates 127 can be formatted as a CAD file, such as an AutoCAD file, a Fusion 360 file, or other various file types used in CAD software. A template 127 can include placeholders or templating fields for any information stored on an order 118, including subdivision data 133, lot data 136, house data 139, and additional structure data 142, as well as any information related to subdivision plats 121, lot plans 145, and house plans 124. A template 127 can be retrieved by the plat application 148 and stored in memory as a lot document while being processed by the plat application 148, which ultimately results in the creation of the output lot documents 130.

The output lot documents 130 can represent the final product of plat application 148 using the templates 127, orders 118, subdivision plats 121, lot plans 145, and house plans 124. An output lot document 130 will represent a completely filled out template 127, meaning a template that has replaced any placeholder form data with data specific to a lot, subdivision, order, or house. Additionally, the output lot document 130 can include the drawing of the lot plan 145. In some embodiments, a drawing of the house plan 124 can be placed within the drawing of the lot plan 145 on the output lot document 130.

The client device 106 is representative of a plurality of client devices that can be coupled to the network 112. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications. Such an application can be executed in a client device 106 to access network content served up by the computing environment 109 or other servers, thereby rendering a user interface on the display. To this end, applications can include a browser, a dedicated application, or other executable, and the user interface can include a network page, an application screen, or other user mechanism for obtaining user input. The client device 106 can be configured to execute additional applications, such as email applications, social networking applications, word processors, spreadsheets, or other applications. Additionally, the client device 106 can be configured to interact with a data environment 103 so the client device 106 can access the data store 115. The client device 106 can include applications configured to connect to the data store 115 such as Sequel Pro, Navicat, or other software applications configured to provide access to an external datastore. The client device 106 can be configured to create, read, update, and delete various records in the data store 115, as well as various other actions.

The computing environment 109 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 109 can employ a plurality of computing devices that can be arranged in one or more server banks or computer banks or other arrangements. Such computing devices can be located in a single installation or can be distributed among many different geographical locations. For example, the computing environment 109 can include a plurality of computing devices that together can include a hosted computing resource, a grid computing resource, or any other distributed computing arrangement. In some cases, the computing environment 109 can correspond to an elastic computing resource where the allotted capacity of processing, network, storage, or other computing-related resources can vary over time.

Various applications or other functionality can be executed in the computing environment 109. The components executed on the computing environment 109 include a plat application 148, imaging software 151, and other applications, services, processes, systems, engines, or functionality not discussed in detail herein.

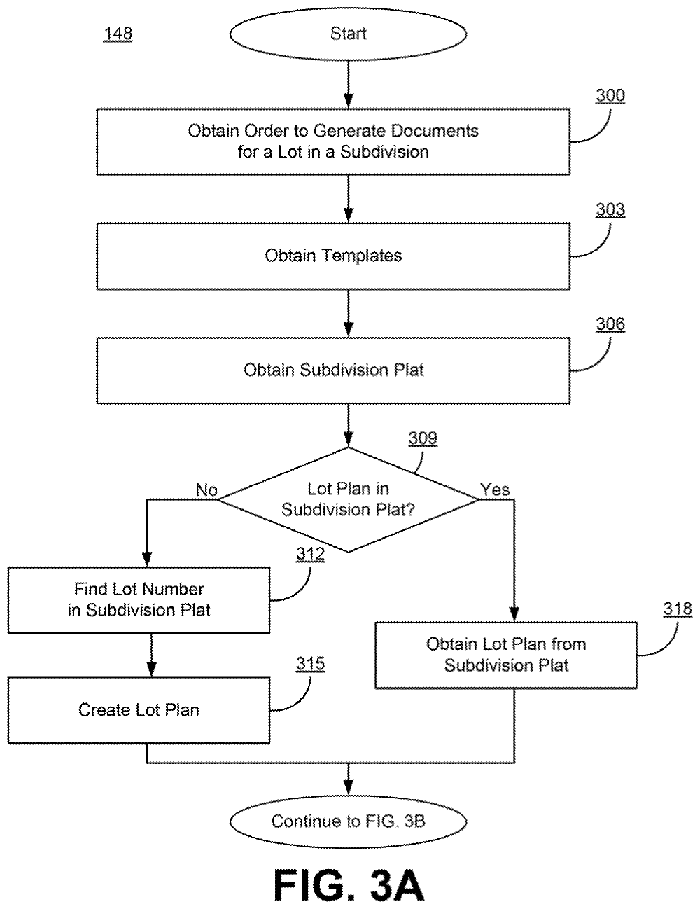

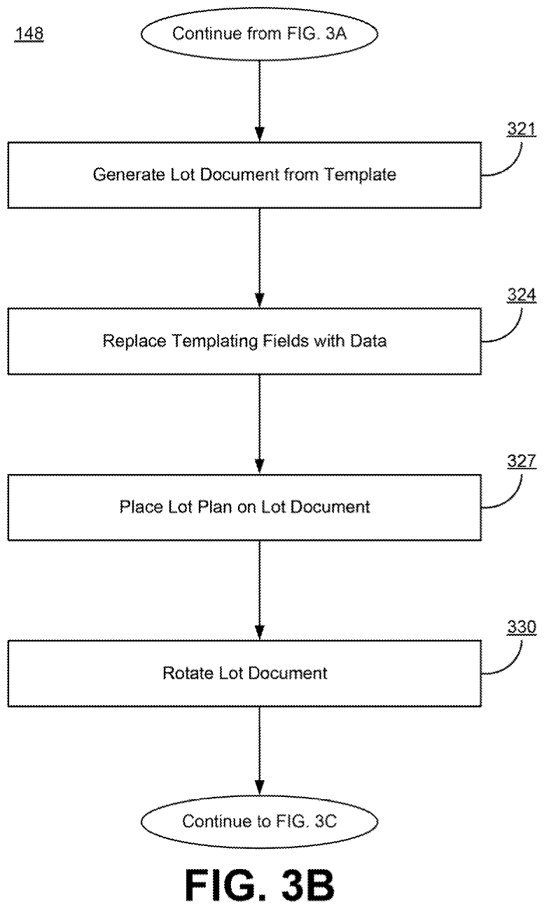

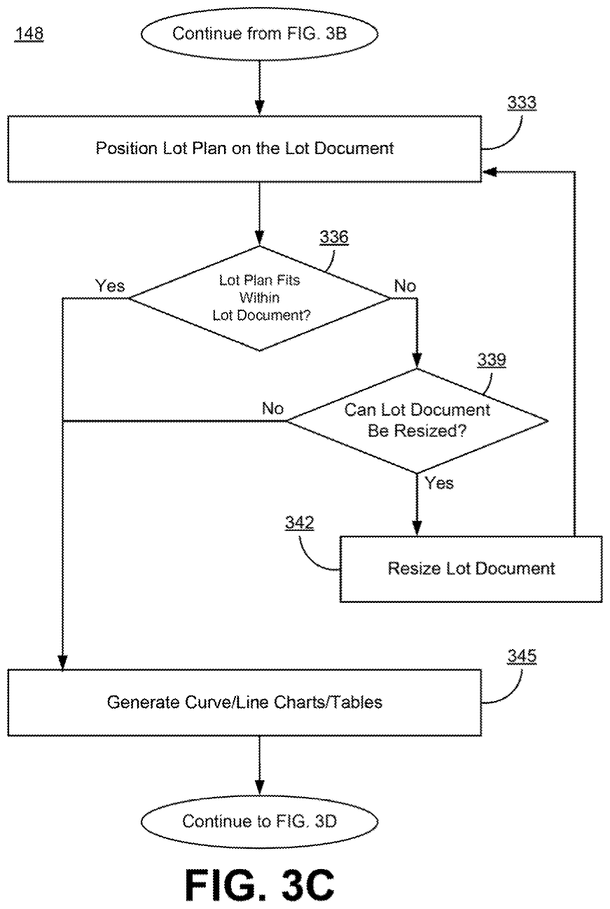

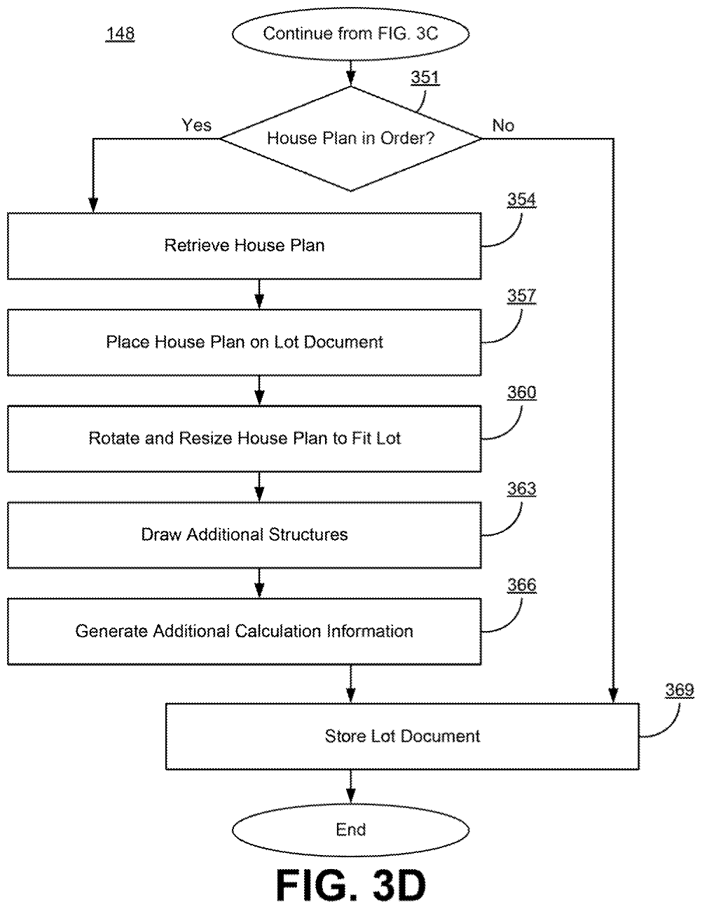

The plat application 148 can be executed to send instructions to, control, or otherwise direct an imaging software 151 to generate output lot documents 130 from subdivision plats 121, house plans 124, templates 127, and orders 118. Operations of the plat application are further detailed in the discussion of FIGS. 3A-D. To briefly describe the functionality of the plat application 148, the plat application 148 begins by obtaining orders 118 that direct the plat application 148 to generate output lot documents 130. The plat application 148 can obtain templates 127 and a specified subdivision plat 121 as specified in the order. The plat application 148 can check to see whether a specified lot plan 145 exists in a subdivision plat 121. If a lot plan 145 does not exist in a subdivision plat 121, the plat application 148 can find a specified lot by a lot number in the subdivision plat 121 and create a lot plan 145 from subdivision plat 121. If the lot plan 145 exists in the subdivision plat 121, then the plat application 148 can obtain the lot plan 145 from the subdivision plat 121. The plat application 148 can then generate a lot document from a template 127 and replace the placeholder templating fields with data from the order 118, the subdivision plat 121, or the lot plan 145. Next, the plat application 148 can direct the imaging software 151 to combine the drawing in the lot plan 145 and the lot document that was generated from the template 127 as a single document. The plat application 148 can direct the imaging software 151 to rotate the lot document independently of the lot plan 145 to ensure the cardinality of the lot is correct for the template 127. The plat application 148 can direct the imaging software 151 to position the lot plan 145 in a specified manner. The plat application 148 can then check if the lot plan 145 fits on the lot document without intersecting with the contents of the lot document. In the situation where the lot plan 145 intersects with the contents of the lot document, the plat application 148 can determine whether the lot document can be resized to fit the lot plan 145. If the lot plan 145 can be resized, the plat application 148 can direct the imaging software 151 to resize the lot document and try to re-position the lot plan 145 on the lot document. If the lot document cannot be resized or if the lot plan 145 fits on the lot document without intersecting its contents, then the plat application 148 can generate curve/line charts and data. The plat application 148 can then format the lot document and lot plan 145 according to the final scale used. Next, the plat application 148 can check if a house plan 124 is specified in the order 118. If a house plan 124 is not specified in the order 118, the plat application 148 can store the lot document as an output lot document 130 in the data store 115. If a house plan 124 is specified in the order 118, then the plat application 148 can obtain the house plan 124 from the data store 115. The plat application 148 can then combine the drawing of the house plan 124 onto the lot document. The plat application 148 can then direct the imaging software 151 to rotate and resize the house plan to fit in the lot. The plat application 148 can direct the imaging software 151 to draw the additional structures on the lot document. The plat application 148 can then calculate additional information about the house plan 124 as it relates to the lot plan 145 on the lot document. Finally, the plat application 148 can store the lot document as an output lot document 130 in the data store 115.

The imaging software 151 can be executed to manipulate, combine, select, or otherwise modify subdivision plats 121, lot plans 145, house plans 124, and templates 127 to generate lot documents held in the memory of the computing environment 109 and subsequently stored as output lot documents 130 in the data store 115 of the data environment 103. Examples of imaging software 151 can include CAD technologies, such as AutoCAD, Fusion 360, and/or other similar software. In at least another embodiment, the imaging software 151 can include a command-line controlled or API controlled image manipulation software, like ImageMagick, FFMPEG, OpenCV, Cloudinary, or similar types of software. The imaging software 151 can also assist in calculating arc length or line length in the lines of a lot plan 145, house plan 124, or other similar document parts.

Referring next to FIGS. 2A-C, shown are pictorial diagrams that depict various examples of subdivision plats 121, house plans 124, and templates 127 as used in at least one embodiment. The pictorial diagrams of FIGS. 2A-C provide merely an example of the many different types of subdivision plats 121, house plans 124, and templates 127 that can be used or generated by the plat application 148. As an alternative, the pictorial diagrams of FIGS. 2A-C can be viewed as depicting incomplete output lot documents 130 as the method of FIGS. 3A-D are being performed by the plat application 148.

To begin, FIG. 2A depicts an example of a drawing in a subdivision plat 121 that may be used by the plat application 148. The subdivision plat 121 depicts various shapes containing numbers 1-28, 30, 32, 34, 36, 38, 40, 42, 44, 46, and 48-60; each one of those shapes represents a lot in the subdivision and each lot is identified by a lot number or lot identifier. As shown, lots 1-28, 30, 32, 34, 36, 38, 40, 42, 44, 46, and 48 are all adjacent to a street entitled “WISTERIA LANE,” and lots 49-60 are adjacent to “SISSON CT.” Additionally, lots 18 and 20 are also adjacent to “MAIN ST.” The subdivision plat 121 can include metadata that identifies which street is the primary ROW for a specific lot.

FIG. 2A also depicts a compass 200 that can be used to identify how the subdivision plat 121 is rotationally situated. This compass includes the letter “N” and a set of intersecting arrows. The plat application 148 can use the compass 200 to determine how much a subdivision plat 121 must rotate to be situated as due north. In at least one embodiment, the amount of rotation required to achieve due north orientation can be stored as data or metadata in the subdivision plat 121.

FIG. 2A also depicts a scale marker 203, which identifies that the specified length of the line corresponds to a much larger size. For instance, the scale marker 203 depicts a horizontal line that extends one inch long with the characters “150 ft” above such horizontal line. This represents that one inch in the document corresponds to one-hundred fifty feet in reality. Please note that even though a scale marker 203 is used as shown, a ratio can also be used to depict the scale between the subdivision plat 121 and the real-world size of the subdivision. Additionally, in at least one embodiment, the scale between the subdivision plat 121 and the real-world size of the subdivision can be stored as data or metadata in the subdivision plat 121.

Moving on to FIG. 2B, depicted is a pictorial diagram of an example drawing of a house plan 124. The drawing of the house plan 124 can include a plurality of lines to depict an enclosed area that represents the house or structure. In some embodiments, the house plan 124 can include measurements of the foundation. In some embodiments, a scale marker could be used to denote the measurements of the foundation (not shown). Additionally, the house plan 124 can include any additional structures that may need to be displayed in an output lot document 130 accounted for, such as a paved driveway.

Moving on to FIG. 2C, depicted is a pictorial diagram of an example template 127 that has a drawing of a lot plan 145 from the subdivision plat 121 of FIG. 2A with a house plan 124 of FIG. 2C placed within the boundaries of the lot plan 145. The template 127 shows various drawings, such as drawings of the lot plan 145 and drawings of the house plan 124. Additionally, the template 127 contains information including a compass 206, a scale marker 209, an address 212, calculation data 215, as well as various other data on the template 127 that needs to be completed, filled-in, or replaced. The lot plan 145 can be placed on the template 127 according to various rules further discussed in FIGS. 3A-D. The house plan 124 can be placed on the lot plan 145 according to various rules further discussed in FIGS. 3A-D. The compass 206 and the scale marker 209 can be displayed similarly to the compass 200 and the scale marker 203 discussed in FIG. 2A. In FIG. 2C, the compass 206 merely depicts a partial arrow and the word “north”. The scale marker 209 in FIG. 2C includes a both a relative size marker and a ratio (i.e., 1″=20′). The address 212 field is currently displayed as empty, which is how the template 127 could depict any field for which the plat application 148 does not have data. Such data to fill in the address 212 field could be derived from the order 118, the subdivision data 133, lot data 136, house data 139, subdivision plat 121, and/or lot plan 145. Additionally, FIG. 2C depicts calculation data 215. Calculation data 215 is typically data that is not required to be entered into an order 118, but is rather calculated from the drawing of the lot plan 145 and/or the house plan 124, such as the amount of square footage for depicted portions of the lot or house. Other calculations can include calculating a formula for arc lengths of a lot that does not have perfectly linear boundaries. Once this template 127 is completed with all the data from the order 118, the subdivision data 133, lot data 136, house data 139, subdivision plat 121, and/or lot plan 145 (as further explained in FIGS. 3A-D), the plat application 148 can store such drawings as an output lot document 130.

Referring next to FIGS. 3A-D, shown are flowcharts that provide one example of the operation of a portion of the plat application 148. The flowchart of FIGS. 3A-D provide merely an example of the many different types of functional arrangements that can be employed to implement the operation of the depicted portion of the plat application 148. As an alternative, the flowcharts of FIGS. 3A-D can be viewed as depicting examples of elements of a method implemented within the network environment 100.

Beginning with block 300 as depicted on FIG. 3A, the plat application 148 can obtain an order 118 to generate an output lot document 130 for a specified lot in a subdivision plat 121. The plat application 148 can communicate with the data store 115 in the data environment 103 over the network 112 to obtain orders 118. The data store 115 can provide orders 118 that meet certain filter criteria. For instance, the plat application 146 can request that the data store 115 only provides an order 118 that contains a status that indicates that the order 118 is ready for generating output lot documents 130. The retrieved order 118 can obtain subdivision data 133, lot data 136, house data 139, and additional structure data 142 as previously described in the discussion of FIG. 1.

At block 303, the plat application 148 can obtain a template 127. The plat application 148 can communicate with the data store 115 in the data environment 103 over the network 112 to obtain one or more templates 127. In at least one embodiment, the retrieved order 118 can include one or more template identifiers, which can be used to obtain one or more specified templates 127. In at least another embodiment, the order 118 can omit a template identifier, so a default template 127 can be obtained.

At block 306, the plat application 148 can communicate with the data store 115 in the data environment 103 over the network 112 to obtain a subdivision plat 121. In at least one embodiment, the retrieved order 118 can include a subdivision plat identifier, which can be used to obtain a subdivision plat 121. If an order 118 does not include a subdivision plat identifier, the plat application 148 can end its processing (not shown).

At block 309, the plat application 148 can determine whether the subdivision plat 121 includes an individual lot plan 145. In some embodiments, the subdivision plat 121 can include one or more lot plans 145 that correspond to lots in the subdivision. Each lot plan 145 could be represented as a layer of the subdivision plats 121 or as a distinct object identifiable by the plat application 148. The plat application 148 can inspect the subdivision plat 121 to see if such a layer or distinct object exists and can be identified as a lot plan 145. In some embodiments, the order 118 can include a lot identifier or a lot number, which can be used to identify a specified lot plan 145 in the subdivision plat 121. If the lot plan 145 is included in the subdivision plat 121, the process can continue to block 318. If the lot plan 145 is not included in the subdivision plat 121, the process can continue to block 312.

At block 312, when the lot plan 145 is not included in the subdivision plat 121, the plat application 148 can find the lot identifier or lot number in the drawing of the subdivision plat 121. For instance, the order 118 can include a lot number or a lot identifier. The plat application 148 can use Optical Character Recognition (“OCR”) to find a string of characters that matches the lot number or lot identifier. In at least another embodiment, the plat application 148 could direct the imaging software 151 to detect a string of characters that matches the lot number or lot identifier. For example, the order 118 can include lot number “50.” The plat application 148 can use OCR to find the characters that match lot number “50.” If the lot number exists on the subdivision plat 121, the process can continue to block 315. If the lot number does not exist on the subdivision plat 121, the process can end early (not shown).

At block 315, the plat application 148 can direct the imaging software 151 to identify the border lines of the lot to create a lot plan. To create a lot plan, the plat application 148 can direct the imaging software 151 to find the plurality of lines closest to the lot number or lot identifier that completely encompasses the lot number or lot identifier; these lines will be the lot boundaries and can be selected to generate the drawing of the lot plan 145. Once those lines are selected, the selected pixels can be traced to generate a vector drawing or copied to create a raster drawing. The drawing of the lot can be combined with any lot data 136 in the order 118 to create a lot plan 145, which can be saved as a layer in the subdivision plat 121 or as a separate file in the memory of the computing environment 109. From block 315, the process can continue to block 321 (as shown on FIG. 3B).

If, at block 309, the subdivision plat 121 is determined to include the lot plan 145, then no lot plan is required to be generated so the process continues to block 318. At block 318, the plat application 148 can obtain the lot plan 145 from the subdivision plat 121 and store the lot plan 145 into the memory of the computing environment 109. The plat application 148 can isolate the layer or distinct object that exists in the subdivision plat 121 that represents the lot plan 145. The plat application 148 can then store the lot plan 145 in the memory of the computing environment 109.

Continuing to block 321, as depicted on FIG. 3B, the plat application 148 can create a lot document from the obtained template 127. In one embodiment, the plat application 148 can direct the imaging software 151 to read the template 127 into memory, which generates a new instance of the template 127 that can be identified as the lot document. In another embodiment, the plat application 148 can duplicate, copy, or otherwise replicate the template 127 as a different file, for example the lot document, in order to preserve the original template 127 and to allow the lot document to be modified moving forward.

At block 324, the plat application 148 can replace the templating fields in the lot document with data from the order 118. A template 127 can include placeholders or templating fields for any information stored on an order 118, including subdivision data 133, lot data 136, house data 139, and additional structure data 142, as well as any information related to subdivision plats 121, lot plans 145, and house plans 124. Because the lot document is a copy of a template, as described in block 321, the lot document also includes templating fields. The plat application 148 can identify placeholders or templating fields in the lot document and replace the placeholder or templating field with information from the order 118. The placeholders or templating fields can use predefined words or phrases to represent a specific portion of data to replace the placeholder or templating field. For instance, a template could have the word “<ADDRESS>”, which could be identified by the plat application 148 using the OCR software and could replace that information with the lot address 212 stored in one of the order 118, the lot data 136, or the lot plan 145. In another example, the word “Address:” could be next to a blank area, which the plat application 148 could recognize the “:” character as an indication to include the replacement text to the right of the word “Address:”. If a template has a term or a phrase of a placeholder or a tem plating field that it cannot identify or if it cannot match to any information stored in the order 118, subdivision data 133, lot data 136, house data 139, additional structure data 142, the subdivision plat 121, and/or the lot plan 145, then the plat application 148 can either remove the templating field from the lot document or not replace the templating field from the lot document.

At block 327, the drawing of the lot plan 145 can be placed on the lot document. At this point in time, the lot plan 145 and the lot document are two separate files that the plat application 148 has stored in the memory of the computing environment 109. At block 327, the two separate files, the lot plan 145 and the lot document, can be joined. In most embodiments, the drawing of the lot plan 145 can be placed onto the lot document. The drawing of the lot plan 145 can still be moved independently of the contents of the lot document once the lot plan 145 has been placed onto the lot document.

At block 330, the plat application 148 can direct the imaging software 151 to rotate the lot document. Because a lot plan 145 is extracted from a subdivision plat 121 and the subdivision plat 121 can be cardinally aligned (north, south, east, west, etc.) based on how the surveyor, contractor, or engineer drew the subdivision plat 121, the lot plan 145 may not be correctly aligned to present to a permitting or licensing board that requires the lot to be presented where north is equivalent to the top of the lot document or where the ROW must be aligned with the bottom of the document or any various presentation style. Additionally, rotating the drawing of the lot plan 145 presents various problems. For example, it is difficult to rotate the lot plan 145 and retain absolute certainty that the amount rotated correctly. This is because all rotations must rotate around a specified inflection point. If two images were rotated the same number of degrees around two different inflection points, the two images may be wildly different. To solve this problem, many embodiments instead rotate the lot document independent of the lot plan 145 to ensure that the appropriate alignment is preserved. Because a lot document and a subdivision plat 121 can both include a compass, the lot document can be rotated to align the arrow pointed to north in the compass of the lot document to the compass of the subdivision plats. In at least another embodiment, the lot document can be rotated so that the bottom of the lot document is aligned with the ROW. Once the lot document has been rotated independently of the lot plan 145, both the lot document and the lot plan 145 can be rotated together around the same inflection point, which preserves the alignment of the lot plan 145 with respect to the lot document.

Continuing to block 333 as depicted on FIG. 3C, the plat application 148 can position the lot plan 145 on the lot document. The templates 127 can include a specified area for drawings of a lot plan 145 to be placed. As such, the lot document can include such a specified area. The plat application 148 can move the drawing of the lot plan 145 so that the lot is positioned in the specified area. In at least one embodiment, the plat application 148 can use a best fit algorithm to determine where to place the lot plan 145 onto the lot document. In at least another embodiment, the plat application 148 can find the centroid of the drawing of the lot plan 145, which is similar to finding the centroid of any polygon, and place the centroid in the center of the specified area on the lot document.

At block 336, the plat application 148 can determine whether the lot plan fits within the lot document. Differences of scale can exist between a subdivision plat 121 and the template 127, wherein one can be substantially larger than the other. As such, the plat application 148 can detect whether the lot plan 145 is too large or too small with respect to the lot document. In an embodiment where the lot plan 145 is too large with respect to the lot document, the lot plan 145 is likely to intersect with other portions of the lot document, such as display information, the compass, the scale marker, etc.; the plat application 148 can detect those overlaps. In another embodiment, the lot plan 145 can be too small with respect to the lot document and the lot plan 145 which takes up merely a small fraction of the allotted space. The plat application 148 can detect such scale disparities by comparing a threshold ratio to the ratio of the size of the lot plan 145 with respect to the allotted space of the lot document. If the latter ratio is lesser than the threshold ratio, then the plat application 148 can consider scaling the lot document up. If the lot plan 145 fits within the allotted space of the lot document, the process can continue to block 345. However, if the lot plan 145 does not fit within the allotted space of the lot document as previously described, the process can continue to block 339.

At block 339, the plat application 148 can determine whether the lot document can be resized. In at least some embodiments, the lot document can include a vector image of the content, which means it can scale gracefully without losing precision. In such a situation, the lot document can typically be resized to another scale. In at least some embodiments, the lot document can be a raster image, meaning it cannot scale up without losing precision. However, the template 127, and therefore the lot document, can include various versions of the rasterized images at various scales. Additionally, templates 127 can also include various page sizes, which can be depicted as another scale to which the lot document can be resized. If the plat application 148 determines that there is a different version of the rasterized image that matches the size, then the plat application 148 can likely resize the lot document. If the lot document can be resized, then the process continues to block 342. However, if the lot document cannot be resized, then the process continues to block 345.

At block 342, the plat application 148 can direct the imaging software 151 to resize the lot document. In embodiments where the lot document includes a vector image, the plat application 148 can provide information to scale up or scale down the lot document, such as providing a percentage, a ratio, or a specified size. In embodiments where the lot document includes a raster image, then the plat application 148 can load a scaled up or scaled down version of the raster image to replace the existing lot document. Once the document has been resized, the position of the lot plan 145 may have shifted, so the process returns to block 333 to position the lot plan 145 on the lot document.

At block 345, the plat application 148 can generate curve/line charts. Many jurisdictions require that the borders of the lot be described in a mathematical manner. Additionally, a lot plan 145 can include more than just rigid straight lines. For example, a lot that is on a cul-de-sac would necessarily have at least one lot border that is not linear but is instead a curve. As such, the plat application 148 can calculate the appropriate functions to describe the border of the lot plan 145. The plat application 148 can measure radii of curves, length of lines, and other various measurements to calculate these formulas. Using these calculated formulas, the plat application 148 can generate charts or tables that display the formulas and place such charts or tables on the lot document.

Continuing to block 351 as depicted on FIG. 3D, the plat application 148 can determine whether the order 118 includes instructions to include a house plan 124. The order 118 can include instructions to include a house plan 124 in the house data 139. If the order 118 includes instructions to include a house plan 124, then the process continues to block 354. However, if the order 118 does not include instructions to include a house plan 124, then the process continues to block 369.

At block 354, the plat application 148 can communicate with the data store 115 in the data environment 103 over the network 112 to obtain a house plan 124. In at least one embodiment, the retrieved order 118 can include a house plan identifier, which can be used to obtain a house plan 124. The plat application 148 can send a request to the data store 115 on the data environment 103 to obtain a specified house plan 124. The data store 115 can then send the plat application 148 the specified house plan 124.

At block 357, the drawing of the house plan 124 can be placed on the lot document. By this point, the house plan 124 and the lot document are two separate files that the plat application 148 has stored in the memory of the computing environment 109. At block 357, the two separate files, the house plan 124 and the lot document, can be joined. In most embodiments, the drawing of the house plan 124 can be placed onto the lot document. The drawing of the house plan 124 can still be moved independently of the contents of the lot document once the lot plan 145 has been placed onto the lot document.

At block 360, the plat application 148 can rotate and resize the house plan 124 to fit on the lot. The plat application 148 can first look to the order 118 to see if there are any configurations that may affect the placement or rotation of the house plan 124 onto the lot, such as distance from the ROW, distances from the border of the lot, avoiding certain locations due to topographical hazards, etc. In at least some embodiments, the house plan 124 can be resized to match the scale used in the lot document and the lot plan 145. In at least some embodiments, the house plan 124 can be rotated to ensure access to the ROW. Once the house plan 124 has been resized and rotated, the house plan 124 can be placed over the lot plan 145 on the lot document (see FIG. 2C as an example).

At block 363, the plat application 148 can draw additional structures on the lot document. For example, the order 118 can indicate that a fence needs to be built a specified distance from the border. In such an example, the plat application 148 can direct the imaging software 151 to generate the requisite drawings to demonstrate such a fence. Additional structures can include fences, detached garages, pools, gazebo, sheds, driveways, etc.

At block 366, the plat application 148 can generate the additional calculation information that may be required for permitting. In many jurisdictions, various calculations, such as total square footage of certain structures or percentage of lot occupied by structures, can be required to obtain a building permit or license. The plat application 148 can calculate these totals in various ways. For example, the plat application 148 can calculate the total square footage of certain structures by measuring the borders of such structures and calculating the real-world measurements based on the scale. In various embodiments, the calculation information can be based on one or more of the house plan 123, the lot plan 145, or information in the order 118. For example, the total amount of fencing needed to surround the lot can be based on both the house plan 123 and the lot plan 145; a fence may end at the house, so a certain distance of the fence that is occupied by the space taken by the house can be excluded. In another example, the total amount of concrete needed for the driveway can be based on both the house plan 123 and the lot plan 145; the placement of the house plan 123 on the lot would affect the distance between the house and the ROW, therefore affecting the calculations of concrete. These calculations can then be placed and displayed on the lot document.

At block 369, the plat application 148 can store the lot document as an output lot document 130. The plat application 148 can finalize the lot document and save it as a temporary file in memory. The plat application 148 can then send such a temporary file to be stored on the data store 115 on the data environment over the network 112 as an output lot document 130. Once the output lot document 130 is stored in the data store 115, the process can end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 109.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive an order to generate a lot plan, the order to generate the lot plan comprising a subdivision plat identifier, a specified lot number, a lot template identifier, and orientation data, wherein the orientation data indicates that the lot plan should be oriented with respect to a right of way adjacent to the lot;
receive, from a data store, a subdivision plat based on the subdivision plat identifier, wherein the subdivision plat is representative of a two-dimensional drawing comprising a plurality of lot lines and a plurality of lot numbers;
receive, from the data store, a lot template based on the lot template identifier, wherein the lot template represents a presentation template to display a lot and the lot template comprises at least a compass and a right of way direction;
identify, on the subdivision plat, the specified lot number from the plurality of lot numbers;
trace, using computer aided design (CAD) software, one or more lot lines of the plurality of lot lines in the subdivision plat that enclose the specified lot number to create a lot;
place, using CAD software, the lot onto a lot template;
rotate, using CAD software, the lot template such that the right of way direction of the lot template is aligned with a front edge of the lot; and
store, in the data store, an output document comprising the lot placed on the rotated lot template.

2. The system of claim 1, wherein the lot template comprises an empty area for the lot to be placed, the empty area being a polygonal shape, and wherein the machine-readable instructions further cause the computing device to at least:
determine a centroid of the lot;
determine a centroid of the empty area; and
position the lot template with respect to the lot based at least on the centroid of the lot and the centroid of the empty area.

3. The system of claim 2, wherein positioning the lot template with respect to the lot is further based on at least a best fit algorithm.

4. The system of claim 2, wherein the machine-readable instructions further cause the computing device to at least:
determine that the lot intersects with edges of the empty area; and
resize the lot template so the lot fits within the empty area.

5. The system of claim 1, wherein the order to generate the lot plan further comprises a house plan and house positioning data, the house plan being a two-dimensional drawing that depicts at least a plurality of outer wall lines and wherein the machine-readable instructions further cause the computing device to at least:
select at least the plurality of outer wall lines to identify a house;
place the house onto the lot based at least on the house positioning data;
calculate one or more house plan calculations based at least on the placement of the house relative to the lot; and
generate a calculations block that displays the one or more house plan calculations.

6. The system of claim 5, wherein the order to generate the lot plan further comprises fencing data and wherein the machine-readable instructions further cause the computing device to at least:
generate fencing lines within the lot based at least on the fencing data; and
generate a driveway based at least on a position of a right of way and a position of the house.

7. A method performed by a computing device, the method comprising:
receiving an order to generate a lot plan, the order to generate the lot plan comprising a specified lot number;
receiving, from a data store, a subdivision plat, wherein the subdivision plat is representative of a two-dimensional drawing comprising a plurality of lot lines and a plurality of lot numbers;
identifying the specified lot number from the plurality of lot numbers on the subdivision plat;
tracing one or more lot lines of the plurality of lot lines in the subdivision plat that enclose the specified lot number to create a lot; and
placing the lot onto a lot template, the lot template comprising a direction indicator.

8. The method of claim 7, further comprising:
determining that the order to generate the lot plan further comprises orientation data, wherein the orientation data indicates that the lot plan should be oriented with respect to a right of way adjacent to the lot; and
rotating the lot template so that the right of way is aligned with a border of the lot template.

9. The method of claim 7, wherein the lot template comprises an empty area for the lot to be placed, the empty area being a polygonal shape, and the method further comprises:
determining a centroid of the lot;
determining a centroid of the empty area; and
positioning the lot template with respect to the lot based at least on the centroid of the lot and the centroid of the empty area.

10. The method of claim 9, wherein the positioning the lot template with respect to the lot is further based on at least a best fit algorithm.

11. The method of claim 9, further comprising:
determining that the lot intersects with edges of the empty area; and
resizing the lot template so the lot fits within the empty area.

12. The method of claim 7, wherein the order to generate the lot plan further comprises a house plan and house positioning data, the house plan being a two-dimensional drawing that depicts at least a plurality of outer wall lines, and the method further comprises:
selecting at least the plurality of outer wall lines to identify a house;
placing the house onto the lot based at least on the house positioning data;
calculating one or more house plan calculations based at least on the placement of the house relative to the lot; and
generating a calculations block that displays the one or more house plan calculations.

13. The method of claim 12, wherein the order to generate the lot plan further comprises fencing data and wherein the method further comprises:
generating fencing lines within the lot based at least on the fencing data; and
generating a driveway based at least on a position of a right of way and a position of the house.

14. A non-transitory, computer-readable medium, comprising machine-readable instructions that, when executed by a processor of a computing device, cause the computing device to at least:
receive an order to generate a lot plan, the order to generate the lot plan comprising a specified lot number;
receive a subdivision plat, wherein the subdivision plat is representative of a two-dimensional drawing comprising a plurality of lot lines and a plurality of lot numbers;
identify the specified lot number from the plurality of lot numbers on the subdivision plat;
trace one or more lot lines of the plurality of lot lines in the subdivision plat that enclose the specified lot number to create a lot; and
place the lot onto a lot template, the lot template comprising a direction indicator.

15. The non-transitory, computer-readable medium of claim 14, wherein the machine-readable instructions, when executed by the processor, further cause the computing device to at least:
determine that the order to generate the lot plan further comprises orientation data, wherein the orientation data indicates that the lot plan should be oriented with respect to a right of way adjacent to the lot; and
rotate the lot template so that the right of way is aligned with a border of the lot template.

16. The non-transitory, computer-readable medium of claim 14, wherein the positioning the lot template with respect to the lot is further based on at least a best fit algorithm.

17. The non-transitory, computer-readable medium of claim 14, wherein the machine-readable instructions, when executed by the processor, further cause the computing device to at least:
determine a centroid of the lot;
determine a centroid of the empty area; and
position the lot template with respect to the lot based at least on the centroid of the lot and the centroid of the empty area and based at least on a best fit algorithm.

18. The non-transitory, computer-readable medium of claim 17, wherein the machine-readable instructions, when executed by the processor, further cause the computing device to at least:
determine that the lot intersects with edges of the empty area; and
resize the lot template so the lot fits within the empty area.

19. The non-transitory, computer-readable medium of claim 14, wherein the order to generate the lot plan further comprises a house plan and house positioning data, the house plan being a two-dimensional drawing that depicts at least a plurality of outer wall lines, and wherein the machine-readable instructions, when executed by the processor, further cause the computing device to at least:
select at least the plurality of outer wall lines to identify a house;
place the house onto the lot based at least on the house positioning data;
calculate one or more house plan calculations based at least on the placement of the house relative to the lot; and
generate a calculations block that displays the one or more house plan calculations.

20. The non-transitory, computer-readable medium of claim 14, wherein the order to generate the lot plan further comprises fencing data and wherein the machine-readable instructions, when executed by the processor, further cause the computing device to at least:
generate fencing lines within the lot based at least on the fencing data; and
generate a driveway based at least on a position of a right of way and the a position of the house.
